(19) United States
(12) Patent Application Publication
(10) Pub. No.: US 2023/0229101 A1
(43) Pub. Date: Jul. 20, 2023

(54) HEATER CONTROL DEVICE AND IMAGE FORMING APPARATUS

(71) Applicants: Haruo Shida, Kanagawa (JP); Tsuyoshi Endoh, Kanagawa (JP); Daisuke Hirano, Kanagawa (JP)

(72) Inventors: Haruo Shida, Kanagawa (JP); Tsuyoshi Endoh, Kanagawa (JP); Daisuke Hirano, Kanagawa (JP)

(73) Assignee: Ricoh Company, Ltd., Tokyo (JP)

(21) Appl. No.: 18/061,125

(22) Filed: Dec. 2, 2022

(30) Foreign Application Priority Data
Jan. 17, 2022 (JP) 2022-005105

(51) Int. Cl. G03G 15/20; H05B 1/02; G03G 15/00

(52) U.S. Cl. CPC G03G 15/2039; G03G 15/5004; H05B 1/0202; H05B 1/0241

(57) ABSTRACT

A heater control device includes a triac connected in series between an alternating-current power supply and a heater, the triac including a first main electrode, a second main electrode, and a gate electrode; a phototriac coupler configured to transmit a heater trigger signal to the gate electrode of the triac; a first resistor and a second resistor each of which is connected in series to the phototriac coupler and configured to limit current in accordance with a phase control enable signal indicative of a period of phase control; and a resistor selection circuit configured to select one of the first resistor and the second resistor and connect the selected resistor to the second main electrode of the triac. The first resistor and the second resistor have different rated powers and different breakabilities from each other.

### CROSS-REFERENCE TO RELATED APPLICATIONS

This patent application is based on and claims priority pursuant to 35 U.S.C. §119(a) to Japanese Patent Application No. 2022-005105, filed on Jan. 17, 2022, in the Japan Patent Office, the entire disclosure of which is hereby incorporated by reference herein.

### BACKGROUND

### Technical Field

The present disclosure relates to a heater control device and an image forming apparatus.

### Related Art

A known heater control device of related art has a circuit configuration as illustrated in FIG. 12.

In related art, as illustrated in FIG. 12, under heater control using a triode alternating-current (AC) semiconductor switch (triac), a phototriac coupler PTC100 and a resistor R100 are connected in series between a gate terminal G and a terminal T2 of a triac Q100 on a circuit board. The phototriac coupler PTC100 is connected to a power supply Vcc via a resistor. When the triac is turned on, the resistor R100 limits the current flowing through the phototriac coupler.

When each terminal (G, T1, or T2) of the triac Q100 is disconnected from the wiring pattern of the circuit board and floats, an AC current may directly flow through the resistor R100 used for a current limit and the phototriac coupler PTC100, which may cause smoking or ignition.

To avoid smoking or ignition, it is known that a fuse resistor that is likely to be broken immediately when an overvoltage or overcurrent is applied in an abnormal operation is used as the resistor R100 for the current limit.

### SUMMARY

In one aspect, a heater control device includes a triac connected in series between an alternating-current power supply and a heater, the triac including a first main electrode, a second main electrode, and a gate electrode; a phototriac coupler configured to transmit a heater trigger signal to the gate electrode of the triac; a first resistor and a second resistor each of which is connected in series to the phototriac coupler and configured to limit current in accordance with a phase control enable signal indicative of a period of phase control; and a resistor selection circuit configured to select one of the first resistor and the second resistor and connect the selected resistor to the second main electrode of the triac. The first resistor and the second resistor have different rated powers and different breakabilities from each other.

In another aspect, an image forming apparatus includes the heater control device described above and a fixing device including the heater controlled by the heater control device.

In another aspect, a heater control device includes a triac connected in series between an alternating-current power supply and a heater, the triac including a first main electrode, a second main electrode, and a gate electrode; a first phototriac coupler configured to transmit a heater trigger signal to the gate electrode of the triac; a first resistor connected in series between the second main electrode of the triac and the first phototriac coupler and configured to limit current; a second phototriac coupler configured to transmit a heater trigger signal to the gate electrode of the triac; a second resistor connected in series between the second main electrode of the triac and the second phototriac coupler and configured to limit current; and a selection and driving circuit configured to select and drive one of the first phototriac coupler and the second phototriac coupler. The second resistor has a rated power and a breakability different from a rated power and a breakability of the first resistor.

In another aspect, an image forming apparatus includes the heater control device described above and a fixing device including the heater controlled by the heater control device.

In another aspect, a heater control device includes a triac connected in series between an alternating-current power supply and a heater, the triac including a first main electrode, a second main electrode, and a gate electrode; a phototriac coupler configured to transmit a heater trigger signal to the gate electrode of the triac; two resistors connected in series between the second main electrode of the triac and the phototriac coupler; and a voltage-peak-value suppression circuit configured to reduce a peak of a voltage that is generated at a node between the two resistors in accordance with a phase control enable signal indicative of a period of phase control.

In another aspect, an image forming apparatus includes the heater control device described above and a fixing device including the heater controlled by the heater control device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of a printer as an example of an image forming apparatus including a heater control device according to an embodiment of the present disclosure;

FIG. 2 is a circuit diagram illustrating an example of a system controller included in the heater control device according to the embodiment of the present disclosure;

FIG. 3 is a circuit diagram illustrating an example of a zero crossing detection unit provided in the heater control device according to the embodiment of the present disclosure;

FIG. 4 is a circuit diagram illustrating an example of a functional configuration of a heater control device according to a first embodiment of the present disclosure;

FIG. 5 is a timing chart illustrating an operation of the heater control device according to the first embodiment of the present disclosure;

FIG. 6 is a circuit diagram illustrating an example of a functional configuration of a heater control device according to a second embodiment of the present disclosure;

FIG. 7 is a timing chart illustrating an operation of the heater control device according to the second embodiment of the present disclosure;

FIG. 8 is a circuit diagram illustrating an example of a functional configuration of a heater control device according to a third embodiment of the present disclosure;

FIG. 9 is a timing chart illustrating an operation of the heater control device according to the third embodiment of the present disclosure;

FIG. 10 is a circuit diagram illustrating an example of a functional configuration of a heater control device according to a fourth embodiment of the present disclosure;

FIG. 11 is a timing chart illustrating an operation of the heater control device according to the fourth embodiment of the present disclosure;

FIG. 12 is a circuit diagram illustrating an example of a functional configuration of a heater control device according to related art; and

FIG. 13 is a timing chart illustrating an operation of the heater control device according to the related art.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise. However, elements, types, combinations of elements, shapes of the elements, and relative positions of elements in the embodiments are examples and do not limit the scope of appended claims.

As a comparative example, there is a system in which two resistors having different break characteristics define a current limiting resistor, to decrease the voltage applied to a fuse resistor.

That is, as a comparative example to prevent damage to a phototriac coupler with an inexpensive configuration, there is a triac drive circuit including a triac connected between an alternating-current power supply and a load, and a phototriac coupler that transmits a signal to the triac. In the triac drive circuit, the phototriac coupler, a first resistance element, and a second resistance element are connected in series to a gate terminal of the triac. The breakability of the first resistance element differs from the breakability of the second resistance element.

In the comparative example, the fuse resistor can be prevented from being blown in a normal operation. However, this configuration does not address the disadvantage that the fuse resistor is instantaneously blown in an abnormal operation.

In the heater control device of the related art using the fuse resistor, there is a time from when the phototriac coupler is turned on to when the triac is turned on. As illustrated in FIG. 13, when phase control is performed in a phase F100, a pulse with a high voltage is rapidly applied. At this time, the fuse resistor may be blown even in a normal operation. When the rated power of the fuse resistor is increased to prevent a break of the fuse resistor, the parts cost increases, and furthermore, the fuse resistor is less likely to be broken in an abnormal operation.

With the configuration according to at least one of embodiments of the present disclosure, switching to the current limiting resistor that can withstand a high-voltage pulse input can be performed during phase control of the heater, whereas switching to the resistor that is likely to be broken in an abnormal situation can be performed during full energization control of the heater. Moreover, during phase control, the peak of the voltage that is generated in the current limiting resistor can be reduced.

Features of the disclosure are described in detail referring to the following drawings.

### Image Forming Apparatus

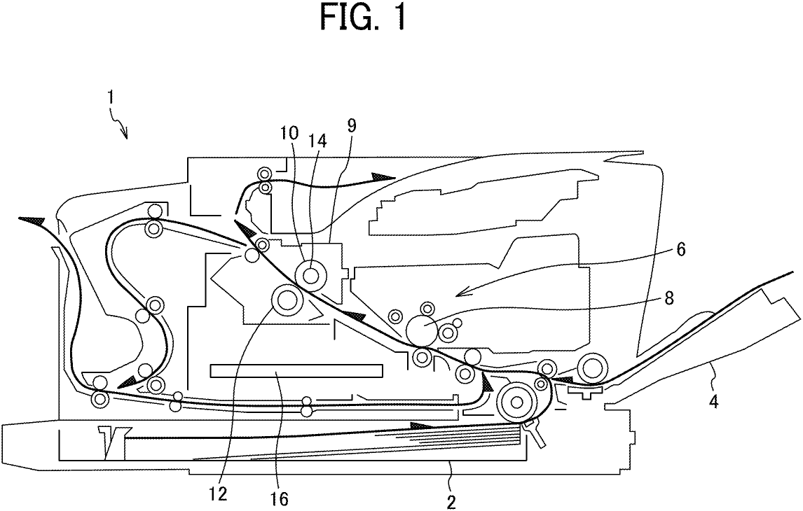

FIG. 1 is a schematic view illustrating a configuration of a printer as an example of an image forming apparatus including a heater control device according to an embodiment of the present disclosure. The image forming apparatus illustrated in FIG. 1 is an image forming apparatus 1 that forms a toner image on a recording sheet by an electrostatic photography system.

A recording sheet fed from a sheet feeding tray 2 or a multi-tray 4 is conveyed to a toner image forming section 6 by a series of conveyance rollers. The toner image forming section 6 forms an electrostatic latent image on a photoconductor drum 8. The electrostatic latent image is developed with toner into a toner image, and the toner image is transferred on the recording sheet.

The recording sheet with the toner image transferred thereon is conveyed to a fixing device 9. The fixing device 9 includes a fixing roller 10 and a pressure roller 12. A heater 14 is incorporated in the fixing roller 10 to heat the fixing roller 10 to a predetermined temperature. When the recording sheet passes through a position between the fixing roller 10 and the pressure roller 12, the toner image transferred on the recording sheet is heated by the fixing roller 10 and is pressed by the pressure roller 12, thereby being fixed to the recording sheet. The recording sheet with the toner image fixed thereto is discharged from the upper side or the front side of the image forming apparatus 1 by a series of rollers.

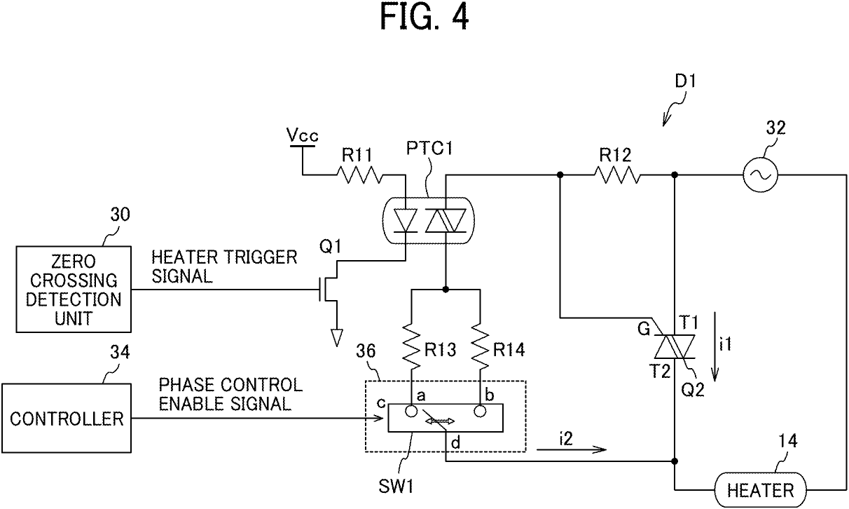

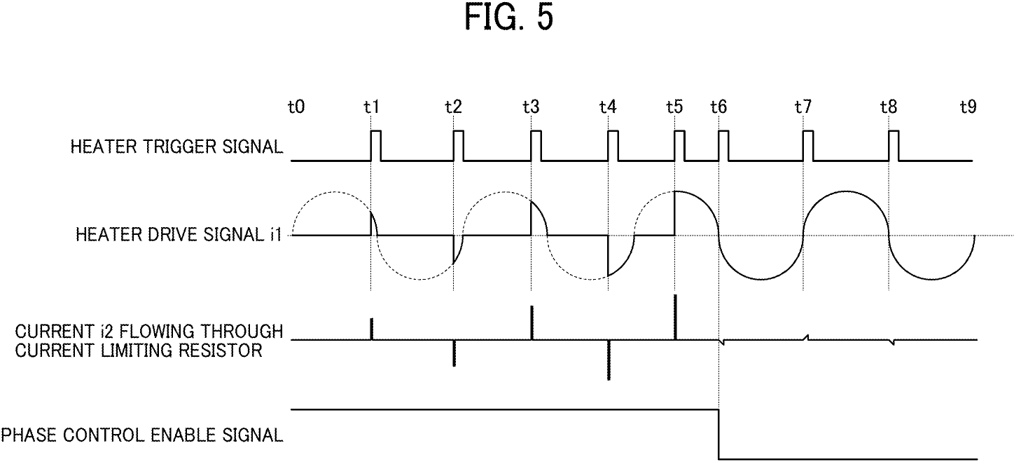

In the image forming apparatus 1 having the above-described configuration, the heater control device according to the embodiment of the present disclosure is used for energization control of the heater 14 in the fixing roller 10. A controller 34 (a control circuit, illustrated in FIG. 4) that controls energization of the heater 14 by a heater control method according to the embodiment of the present disclosure is provided on a control board 16 that is a printed circuit board provided in the body of the image forming apparatus 1.

The heater 14 of the image forming apparatus 1 uses a relatively large power when rapidly heating the fixing roller 10. When the power is supplied to the image forming apparatus 1, for example, internal electronic components and a motor are activated, and hence power consumption increases. Thus, when a large power is applied to the heater 14 in a short time, the power supply voltage fluctuates, and electrical devices in the vicinity of the image forming apparatus 1 may be affected. Thus, energization of the heater is normally controlled by a soft start method to gradually increase the supply voltage to the heater.

### System Controller

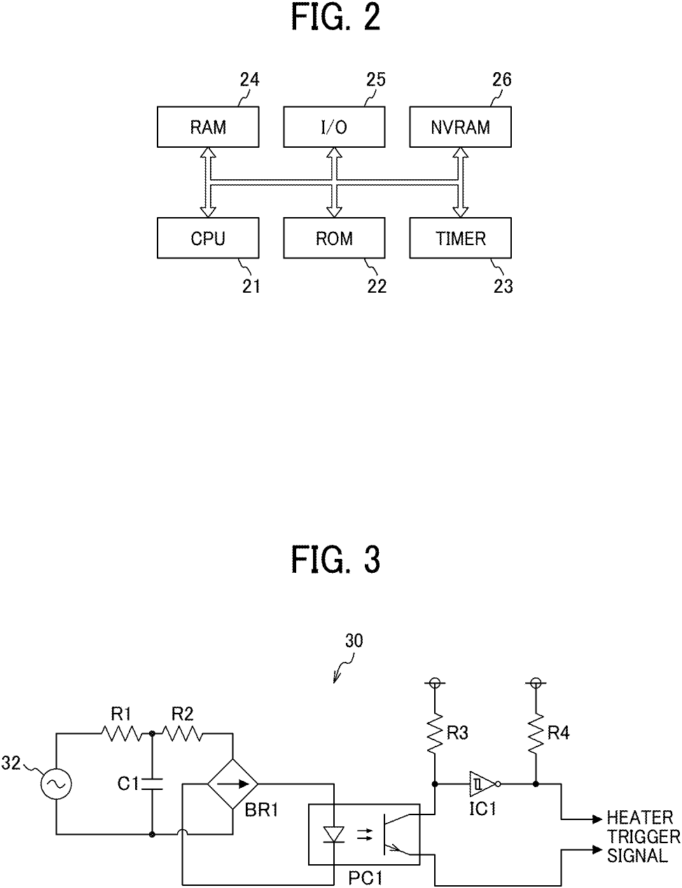

FIG. 2 is a circuit diagram illustrating an example of a system controller included in the heater control device according to the embodiment of the present disclosure.

The system controller includes a central processing unit (CPU) 21, a read-only memory (ROM) 22, a timer 23, a random-access memory (RAM) 24, various input/output (I/O) circuits 25, and a non-volatile memory (NVRAM) 26, which are connected to one another via a system bus.

The CPU 21 performs phase control on a triac Q2 (FIG. 4) of the control board 16 based on a heater trigger signal using a control program, a parameter, and so forth stored in the ROM 22 to control power supply to the heater 14. The CPU 21 has a function of performing overall control on the entire image forming apparatus, such as sequence control on respective components of charging, exposing, developing, and transferring of the photoconductor and the periphery thereof, and conveyance control on a transfer sheet. Functions of a controller related to control on the heater 14 are described below.

The timer 23 includes a plurality of counters that count clock signals, can count up to 65536 at maximum when the counters are, for example, 16-bit counters, and divides the frequency of the clock signals to adjust the count cycle.

### Zero Crossing Detection Unit

FIG. 3 is a circuit diagram illustrating an example of a zero crossing detection unit provided in the heater control device according to the embodiment of the present disclosure.

The heater control device includes a power supply unit, and the power supply unit is provided with a zero crossing detection unit 30.

As illustrated in FIG. 3, the zero crossing detection unit 30 full-wave rectifies an alternating-current power supply 32 supplied from a commercial power supply in a diode bridge BR1 via a circuit including resistors R1 and R2 that function as a low pass filter and a current limit, and a capacitor C1. The full-wave rectified pulsating signal is transmitted in an insulated manner by a photocoupler PC1 including a light emitting diode (LED) and a phototransistor (PT), and is input to a hysteresis inverter IC1 to generate a heater trigger signal (zero crossing signal). Resistors R3 and R4 are pull-up resistors for applying a positive voltage.

The heater trigger signal detected (generated) by the zero crossing detection unit 30 is supplied to, for example, a gate terminal of a transistor Q1 illustrated in FIG. 4, and has a waveform of a rectangular wave as illustrated in FIG. 5.

### First Embodiment

### Heater Control Device

FIG. 4 is a circuit diagram including a functional configuration of an example of a heater control device D1 according to a first embodiment of the present disclosure.

The heater control device D1 includes a triac Q2, a phototriac coupler PTC1, resistors R13 and R14, a resistor selection circuit 36, and a transistor Q1.

The triac Q2 is connected in series between an alternating-current power supply 32 and a heater 14. As used herein, the term “connected/coupled” includes both direct connections and connections in which there are one or more intermediate connecting elements.

The phototriac coupler PTC1 transmits a heater trigger signal to a gate electrode G of the triac Q2.

Each of the resistors R13 and R14 is connected in series to the phototriac coupler PTC1. The resistors R13 and R14 are two resistors having different rated powers and different breakabilities and used to limit current in accordance with a phase control enable signal indicative of a period of phase control.

The resistor selection circuit 36 selects one resistor of the resistors R13 and R14 serving as the two resistors to connect the selected resistor to a second main electrode T2 of the triac Q2.

The heater control device D1 includes, as the two resistors, the resistor R13 connected in series to the phototriac coupler PTC1, and the resistor R14 connected in series to the phototriac coupler PTC1 and having a rated power and a breakability different from the rated power and the breakability of the resistor R13.

The resistor selection circuit 36 includes a switch circuit SW1 that selects and couples one of the resistor R13 and the resistor R14.

The heater control device D1 includes a controller 34.

The controller 34 generates a phase control enable signal indicative of a period of phase control.

The resistor selection circuit 36 selects a resistor in accordance with the phase control enable signal supplied from the controller 34.

An image forming apparatus 1 includes the heater control device D1 and a fixing device 9 incorporating the heater 14 that is controlled by the heater control device D1.

In FIG. 4, the commercial alternating-current power supply (alternating-current power supply) 32 and the heater 14 are coupled to each other via a terminal T1 and the terminal T2 of the triac Q2.

The triac Q2 is energized/de-energized (is turned on/off) to control the power to be supplied to the heater 14. When a light emitting diode in the phototriac coupler PTC1 that ensures electrical isolation between a primary side and a secondary side is energized, the triac Q2 is turned on.

A resistor R11 is a resistance element for limiting the current of the light emitting diode in the phototriac coupler PTC 1.

The transistor Q1 turns on/off the phototriac coupler PTC1 in accordance with a heater trigger signal. That is, a gate terminal of the transistor Q1 is connected to the zero crossing detection unit 30, and hence the transistor Q1 operates in accordance with a heater trigger signal output from the zero crossing detection unit 30.

A resistor R12, the resistor R13, or the resistor R14 connected to the phototriac coupler PTC1 functions as a bias resistor for driving the triac Q2.

The resistor selection circuit 36 selects one resistor of the resistors R13 and R14 serving as the two resistors to connect the selected resistor to a second main electrode T2 of the triac Q2.

The resistor selection circuit 36 includes the switch circuit SW1.

One end of the resistor R13 and one end of the resistor R14 are commonly connected to one end of the phototriac coupler PTC1, the other end of the resistor R13 is connected to a first contact a of the switch circuit SW1, and the other end of the resistor R14 is connected to a second contact b of the switch circuit SW1.

The phase control enable signal is supplied from the controller 34 to a control terminal c of the switch circuit SW1, and when the phase control enable signal is in a high state (substantially equal to a voltage value of Vcc), the first contact a of the switch circuit SW1 is selected, and the other end of the resistor R13 is connected to the second main electrode T2 of the triac Q2 and the heater 14 via an output terminal d of the switch circuit SW1. In contrast, when the phase control enable signal is in a low state (substantially equal to a voltage value of the ground of the control board 16), the second contact b of the switch circuit SW1 is selected, and the other end of the resistor R14 is connected to the second main electrode T2 of the triac Q2 and the heater 14 via the output terminal d of the switch circuit SW1.

When phase control is performed on the heater 14, the resistor selection circuit 36 selects the resistor R13 (first resistor) using the switch circuit SW1 to connect the resistor R13 (first resistor) in series to the phototriac coupler PTC1.

In contrast, when full energization control is performed on the heater 14, the resistor selection circuit 36 selects the resistor R14 (second resistor) using the switch circuit SW1 to connect the resistor R14 (second resistor) in series to the second main electrode T2 of the triac Q2.

As illustrated in FIG. 4, the transistor (field-effect transistor, FET) Q1 is turned on/off in accordance with the voltage level of the heater trigger signal supplied from the zero crossing detection unit 30 to energize/de-energize the photodiode of the phototriac coupler PTC1 from Vcc. That is, when the heater trigger signal is in a high level, the photodiode of the phototriac coupler PTC1 is energized to emit light, whereas when the heater trigger signal is in a low level, the photodiode of the phototriac coupler PTC1 is de-energized to be turned off.

In the heater control device D1 illustrated in FIG. 4, the current limiting resistor (resistor R13) that is connected to the second main electrode T2 of the triac Q2 is selected during phase control in accordance with the phase control enable signal supplied from the controller 34.

For example, during phase control, the phase control enable signal is in a high state, and the switch circuit SW1 selects the resistor R13. In contrast, during full energization control, the phase control enable signal is in a low state, and the switch circuit SW1 selects the resistor R14.

### Resistors R13 and R14

In this case, a resistor (for example, a metal oxide film resistor) that can withstand a high-voltage pulse is used as the resistor R13, whereas a fuse resistor that is likely to be broken in an abnormal situation such as when an overcurrent is generated is used as the resistor R14.

The fuse resistor is a resistor that normally functions as a resistance element and that has a function of safely blowing the resistance body and interrupting the circuit current in an abnormal situation.

When the heater 14 is fully energized, the voltage applied to the resistor R14 slowly increases with the inclination of the input AC voltage, so that the triac Q2 is turned on before the voltage becomes a high voltage. Hence, the voltage applied to the resistor R14 does not increase. Thus, a fuse resistor having a small rated power can be used as a resistor that is likely to be broken. In an abnormal situation such as when an overcurrent is generated, a voltage similar to that in full energization control is applied to the resistor R14, so that the fuse resistor having the small rated power is easily broken.

In contrast, the metal oxide film resistor has very high pulse resistance as compared to the pulse resistance of the fuse resistor in the case of the same rated power, and the parts cost of the metal oxide film resistor is markedly lower than the parts cost of the fuse resistor. Even when a high-voltage pulse is input, the metal oxide film resistor can keep (withstand) a conductive state with a small rated power without interruption.

For example, in terms of design, a metal oxide film resistor having a rated power of 0.1 W can be used as the resistor R13.

In contrast, a fuse resistor having a rated power of 0.25 W can be used as the resistor R14.

### Operation Timing

FIG. 5 is a timing chart illustrating an operation of the heater control device D1 according to the first embodiment of the present disclosure.

FIG. 5 illustrates an example in which the phase control enable signal is in a high state during phase control and is in a low state in the other situation (for example, during full energization control).

The operation of the heater control device D1 illustrated in FIG. 4 is described below referring to the timing chart illustrated in FIG. 5.

For example, at timings t1 and t2, when the heater trigger signal is switched from the low state to the high state, the triac Q2 is turned on and is in a conductive state until the AC voltage of the alternating-current power supply 32 becomes 0 V, and a heater drive signal i1 flows through the heater 14.

In a period from a timing t0 to a timing t6, the triac Q2 is turned on in a desirable phase of the AC voltage during phase control, and the conductive state is kept until the AC voltage becomes 0 V. During phase control, the voltage rapidly rises from 0 V to the AC voltage at that time point. In a period until the phototriac coupler PTC1 is turned on and the triac Q2 is turned on, a current i2 also rapidly increases in accordance with the rapid voltage.

In contrast, in a period from the timing t6 to a timing t9, the triac Q2 is turned on at a timing at which the AC voltage of the alternating-current power supply 32 becomes 0 V during full energization control. During full energization control, the voltage rises slowly in accordance with the AC voltage, and hence the current i2 does not rapidly increase even when there is a time difference between when the phototriac coupler PTC1 is turned on and when the triac Q2 is turned on.

### Second Embodiment

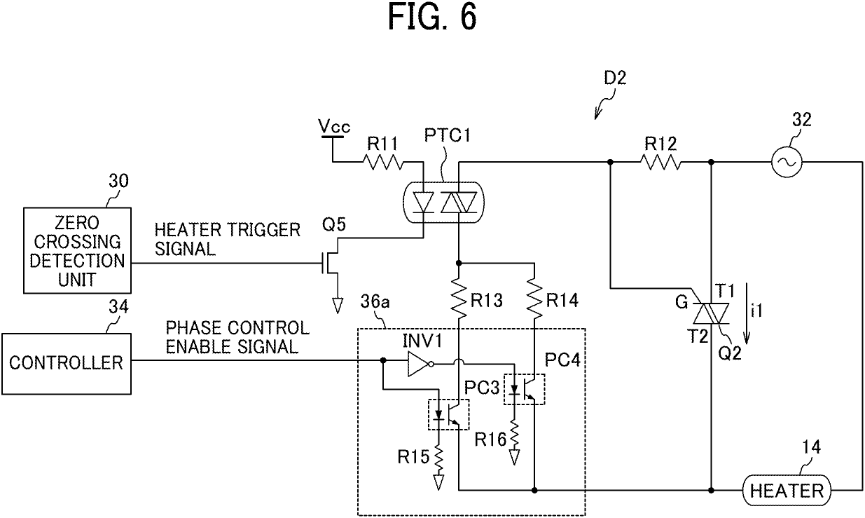

FIG. 6 is a circuit diagram including a functional configuration of an example of a heater control device D2 according to a second embodiment of the present disclosure.

The heater control device D2 includes, as two resistors, a resistor R13 connected in series to a phototriac coupler PTC1, and a resistor R14 connected in series to the phototriac coupler PTC1 and having a rated power and a breakability different from the rated power and the breakability of the resistor R13.

A resistor selection circuit 36a includes a photocoupler PC3 connected in series to the resistor R13, and a photocoupler PC4 connected in series to the resistor R14.

When phase control is performed on a heater 14, that is, when a phase control enable signal is in a high state, the resistor selection circuit 36a turns on the photocoupler PC3 to connect the resistor R13 and a second main electrode T2 of a triac Q2 in series to the phototriac coupler PTC1.

In contrast, when full energization control is performed on the heater 14, that is, when the phase control enable signal is in a low state, the resistor selection circuit 36a turns on the photocoupler PC4 to connect the resistor R14 and the second main electrode T2 of the triac Q2 in series to the phototriac coupler PTC1.

The heater control device D2 includes a controller 34.

The controller 34 generates a phase control enable signal indicative of a period of phase control.

The resistor selection circuit 36a selects a resistor in accordance with the phase control enable signal supplied from the controller 34.

An image forming apparatus 1 includes the heater control device D2 and a fixing device 9 incorporating the heater 14 that is controlled by the heater control device D2.

In the second embodiment, two sets each including a resistor and a photocoupler connected in series are provided as the resistor selection circuit 36a. That is, the photocoupler PC3 that operates when the phase control enable signal is in the high state (substantially equal to a voltage value of Vcc) during phase control and the photocoupler PC4 that operates when the phase control enable signal is in the low state (substantially equal to a voltage value of the ground of a control board 16) during full energization control are provided, and the path and the resistance value during phase control are changed.

A resistor R11 is a resistance element for limiting the current of a light emitting diode provided in the phototriac coupler PTC1.

A heater trigger signal output from a zero crossing detection unit 30 is input to a gate terminal of a transistor Q5. The transistor Q5 turns on/off the phototriac coupler PTC1 in accordance with the heater trigger signal.

The phase control enable signal output from the controller 34 is input to a light emitting diode of the photocoupler PC3, and is further grounded to the GND via a resistor R15. A collector of a phototransistor of the photocoupler PC3 is coupled to the phototriac coupler PTC1 via the resistor R13, and an emitter thereof is coupled to the heater 14.

The phase control enable signal output from the controller 34 is input to a light emitting diode of the photocoupler PC4 via an inverter INV1, and is grounded to the GND via a resistor R16. A collector of a phototransistor of the photocoupler PC4 is connected to the phototriac coupler PTC1 via the resistor R14, and an emitter thereof is connected to the heater 14.

### Operation Timing

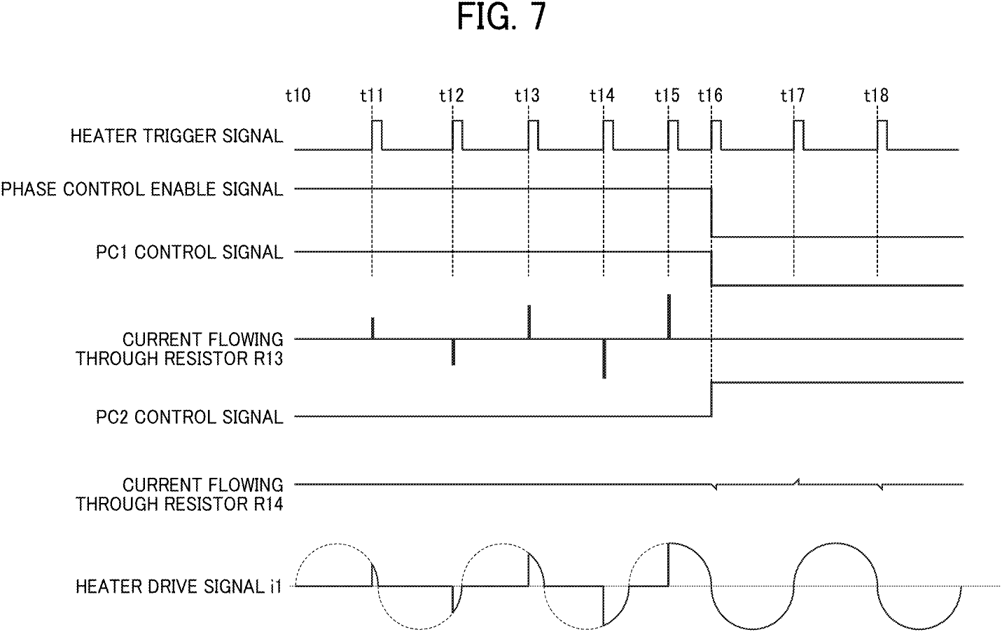

FIG. 7 is a timing chart illustrating an operation of the heater control device D2 according to the second embodiment of the present disclosure.

### During Phase Control

When the phase control enable signal output from the controller 34 is in a high state, the light emitting diode of the photocoupler PC3 is grounded to the GND via the resistor R15, and the light emitting diode emits light, thereby turning on the phototransistor of the photocoupler PC3. When the phototransistor is turned on, the resistor R13 is connected to the heater 14 via the collector and emitter of the phototransistor.

At this time, the heater trigger signal output from the zero crossing detection unit 30 turns on/off the transistor Q5.

During phase control, the phototransistor of the photocoupler PC3 is turned on, and the path of the resistor R13 is used. As described above, a resistor (for example, a metal oxide film resistor) that can withstand a high-voltage pulse even when the high-voltage pulse is input can be used as the resistor R13.

### During Full Energization Control

When the phase control enable signal output from the controller 34 is in a low state, the output of the inverter INV1 becomes a high state, the light emitting diode of the photocoupler PC4 is grounded to the GND via the resistor R16, and the light emitting diode emits light, thereby turning on the phototransistor of the photocoupler PC4. When the phototransistor is turned on, the resistor R14 of the phototransistor is connected to the heater 14 via the collector and emitter of the phototransistor.

At this time, the heater trigger signal output from the zero crossing detection unit 30 turns on/off the transistor Q5.

During full energization control, the phototransistor of the photocoupler PC4 is turned on, and the path of the resistor R14 is used. As described above, a fuse resistor that is likely to be broken in an abnormal situation such as when an overcurrent is generated can be used as the resistor R14.

### Third Embodiment

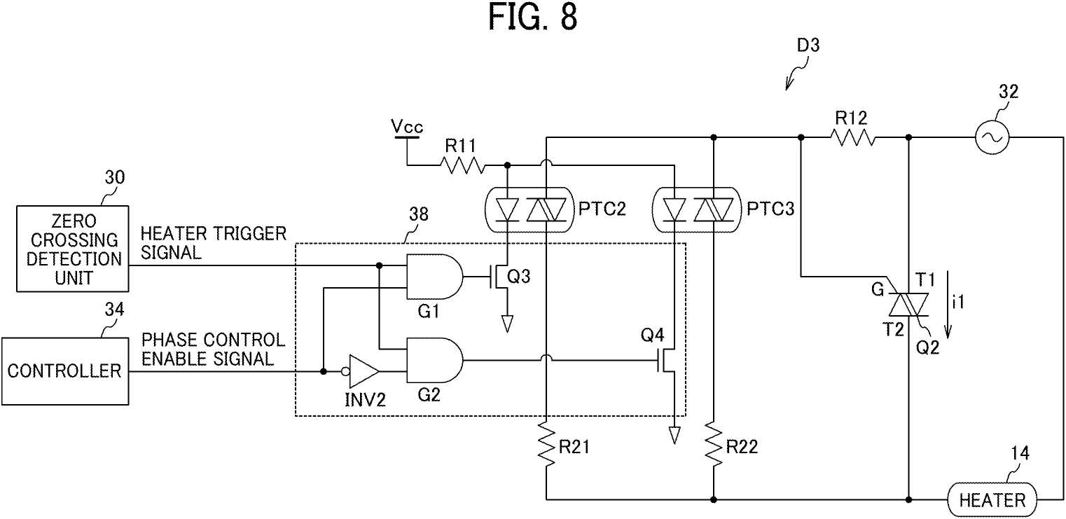

FIG. 8 is a circuit diagram including a functional configuration of an example of a heater control device D3 according to a third embodiment of the present disclosure.

The heater control device D3 includes a triac Q2, a phototriac coupler PTC2, a resistor R21, a phototriac coupler PTC3, a resistor R22, and a selection and driving circuit 38.

A resistor R11 is a resistance element for limiting the current of each of light emitting diodes provided in the phototriac coupler PTC2 and the phototriac coupler PTC3.

The triac Q2 is coupled in series between an alternating-current power supply 32 and a heater 14. As used herein, the term “connected/coupled” includes both direct connections and connections in which there are one or more intermediate connecting elements.

The phototriac coupler PTC2 transmits a heater trigger signal to a gate electrode G of the triac Q2.

The resistor R21 is used for a current limit connected in series between a second main electrode T2 of the triac Q2 and the phototriac coupler PTC2.

The phototriac coupler PTC3 transmits a heater trigger signal to the gate electrode G of the triac Q2.

The resistor R22 is connected in series between the second main electrode T2 of the triac Q2 and the phototriac coupler PTC3, and is used for a current limit having a rated power and a breakability different from the rated power and the breakability of the resistor R21.

The selection and driving circuit 38 selects and drives one of the phototriac coupler PTC2 and the phototriac coupler PTC3.

The phototriac coupler PTC2 is turned on/off by a transistor Q3.

The transistor Q3 turns on/off the phototriac coupler PTC2 in accordance with a signal that is input to a gate terminal of the transistor Q3.

In the selection and driving circuit 38, the gate terminal of the transistor Q3 is connected to an output terminal of an AND gate G1. One of input terminals of the AND gate G1 is connected to the zero crossing detection unit 30 and receives a heater trigger signal. The other input terminal of the AND gate G1 is connected to a controller 34 and receives a phase control enable signal.

In contrast, a transistor Q4 turns on/off the phototriac coupler PTC3 in accordance with a signal that is input to a gate terminal of the transistor Q4.

In the selection and driving circuit 38, the gate terminal of the transistor Q4 is connected to an output terminal of an AND gate G2. One of input terminals of the AND gate G2 is connected to the zero crossing detection unit 30 and receives the heater trigger signal. The other input terminal of the AND gate G2 is connected to the phase control enable signal of the controller 34 via an inverter INV2.

When phase control is performed on the heater 14, the selection and driving circuit 38 turns on the phototriac coupler PTC2 to couple the resistor R21 in series to the phototriac coupler PTC2.

An image forming apparatus 1 includes the heater control device D3 and a fixing device 9 incorporating the heater 14 that is controlled by the heater control device D3.

In the third embodiment, two sets each including a resistor and a phototriac coupler are provided. That is, a logic circuit corresponding to a combination of the level state (logic value) of the heater trigger signal and the level state (logic value) of the phase control enable signal is provided, and the path and the resistance value during phase control are changed.

### Operation Timing

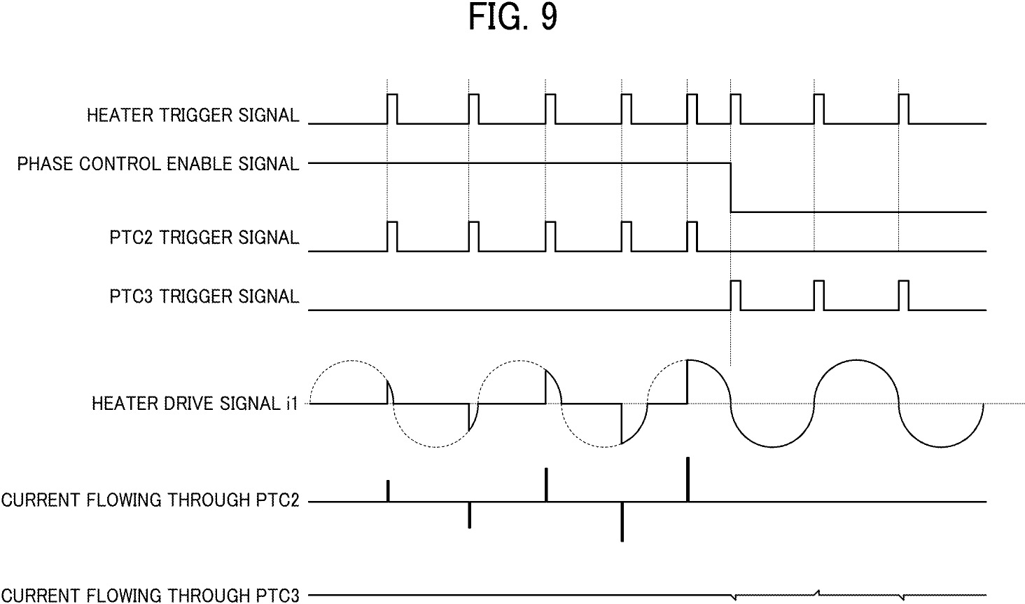

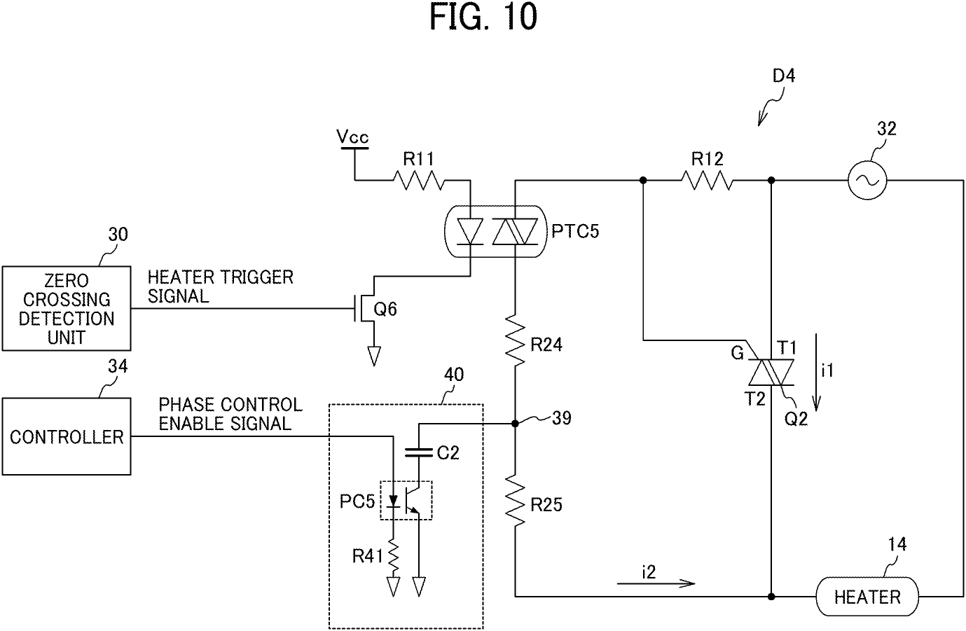

FIG. 9 is a timing chart illustrating an operation of the heater control device D3 according to the third embodiment of the present disclosure.

### During Phase Control

When the phase control enable signal of the controller 34 is in a high state, the other input terminal of the AND gate G1 becomes a high state, and hence the heater trigger signal output from the zero crossing detection unit 30 turns on/off the transistor Q3 via the AND gate G1.

During phase control, the phototriac coupler PTC2 is turned on/off to bring into conduction the path of the resistor R21 that can withstand a high-voltage pulse input.

### During Full Energization Control

When the phase control enable signal of the controller 34 is in a low state, the output of the inverter INV2 becomes a high state and the other input terminal of the AND gate G2 is in a high state, and hence the heater trigger signal output from the zero crossing detection unit 30 turns on/off the transistor Q4 via the AND gate G2.

During full energization control, the phototriac coupler PTC3 is turned on/off to bring into conduction the path of the resistor R22 using a fuse resistor that is likely to be broken in an abnormal situation such as when an overcurrent is generated.

### Fourth Embodiment

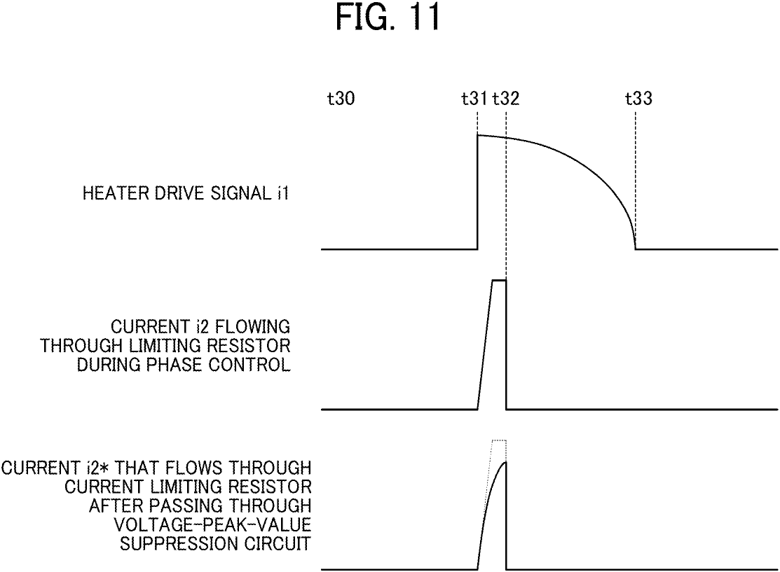

FIG. 10 is a circuit diagram including a functional configuration of an example of a heater control device D4 according to a fourth embodiment of the present disclosure.

In a comparative example, two fuse resistors are connected in series to a phototriac coupler, and further connected to a second main electrode of a triac to decrease the voltage applied to the fuse resistors.

In contrast, the heater control device D4 according to the fourth embodiment includes a triac Q2, a phototriac coupler PTC5, a resistor R24, a resistor R25, and a voltage-peak-value suppression circuit 40.

The triac Q2 is coupled in series between an alternating-current power supply 32 and a heater 14.

The phototriac coupler PTC5 transmits a heater trigger signal to a gate electrode G of the triac Q2.

The resistor R24 and the resistor R25 are two resistors connected in series between the phototriac coupler PTC5 and a second main electrode T2 of the triac Q2.

The voltage-peak-value suppression circuit 40 reduces a peak of a voltage that is generated at a node 39 between the resistors R24 and R25 serving as the two resistors in accordance with a phase control enable signal indicative of a period of phase control.

The voltage-peak-value suppression circuit 40 includes a capacitor C2 and a photocoupler PC5.

One end of the capacitor C2 is connected to the node 39 between the resistor R24 and the resistor R25 serving as the two resistors.

The photocoupler PC5 is connected to the other end of the capacitor C2.

When phase control is performed on the heater 14, the voltage-peak-value suppression circuit 40 turns on a transistor of the photocoupler PC5 and grounds the capacitor C2 connected to the node 39 to define a low pass filter circuit.

A heater trigger signal output from a zero crossing detection unit 30 is input to a gate terminal of a transistor Q6. The transistor Q6 turns on/off the phototriac coupler PTC5 in accordance with the heater trigger signal.

When the phase control enable signal output from the controller 34 is in a high state, the light emitting diode of the photocoupler PC5 is grounded to the GND via a resistor R41.

An image forming apparatus 1 includes the heater control device D4 and a fixing device 9 incorporating the heater 14 that is controlled by the heater control device D4.

Furthermore, the voltage-peak-value suppression circuit 40 reduces peaks of voltages that are generated in the resistors R24 and R25 in accordance with the phase control enable signal indicative of the period of phase control.

The voltage-peak-value suppression circuit 40 includes the capacitor C2 connected to the node 39 between the resistor R24 and the resistor R25 serving as the two resistors, and the photocoupler PC5 connected to the capacitor C2. The voltage-peak-value suppression circuit 40 turns on the photocoupler PC5 and grounds the capacitor C2 connected to the node 39 to define a low pass filter circuit when phase control is performed on the heater 14.

The voltage-peak-value suppression circuit 40 inhibits rising of a voltage that is applied to a resistor during phase control in accordance with a phase control enable signal that is supplied from a controller 34.

During phase control, for example, the low pass filter circuit is provided to moderate rising of the voltage that is applied to the resistor when the triac Q2 is on.

The one end of the capacitor C2 is connected to the node 39 between the resistor R24 (first resistor) and the resistor R25 (second resistor) connected in series, and the other end of the capacitor C2 is grounded during phase control in accordance with the phase control enable signal supplied from the controller 34 in the voltage-peak-value suppression circuit 40 illustrated in FIG. 10.

Thus, the resistor R24 (first resistor) and the capacitor C2 define the low pass filter circuit, and the voltage that is applied to the node 39 between the resistor R24 (first resistor) and the resistor R25 (second resistor) can be decreased (rising can be moderated) at a time (t31 in FIG. 11) when the triac is on.

### Operation Timing

FIG. 11 is a timing chart illustrating an operation of the heater control device D4 according to the fourth embodiment of the present disclosure.

The timing chart illustrated in FIG. 11 presents, from the upper side to the lower side of the figure; (1) a heater drive signal i1; (2) a current i2 that flows through a current limiting resistor (resistor R100) during phase control in the related art; and (3) a current i2* that flows through a current limiting resistor (resistor R24 and resistor R25) after the current passes through the voltage-peak-value suppression circuit 40.

As illustrated in FIG. 11, at timings t30 and t31, when the heater drive signal i1 is switched from a low state to a high state, the triac Q2 is turned on and is in a conductive state until the AC voltage of the alternating-current power supply 32 becomes 0 V (timing t33), and the heater drive signal i1 flows through the heater 14.

For example, about 1 microsecond is expected as a case where the time until the phototriac coupler PTC5 is turned on is short between the timing t30 and the timing t31.

Also, for example, about 10 microseconds is expected as a case where the time until the triac Q2 is turned on is long.

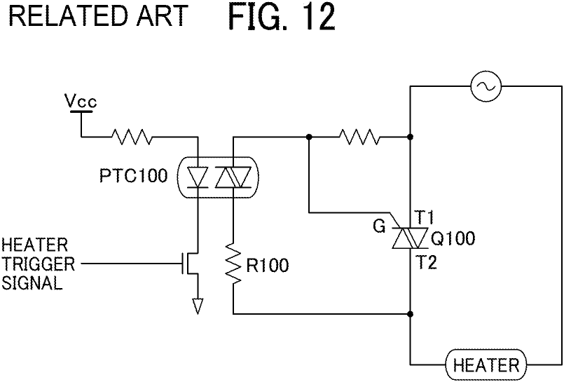

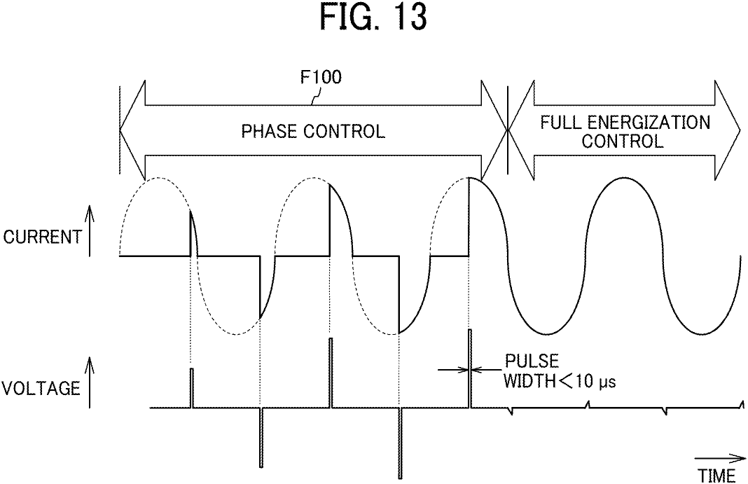

At timings t31 and t32, the peak value of the current i2* after passing through the voltage-peak-value suppression circuit 40 according to the embodiment of the present disclosure can be reduced to about ⅓ to ½ of the peak value of the current i2 flowing through the current limiting resistor R100 during phase control according to the related art (FIG. 12).

Compared to the configuration in which the two resistors are connected in series like the configuration of the comparative example, by employing the voltage-peak-value suppression circuit 40 according to the embodiment of the present disclosure, a fuse resistor having a small rated power can be used. Since the rated power is small, a break in an abnormal situation is easily performed.

### First Aspect

According to this aspect, the heater control device D1 includes: the triac Q2 connected in series between the alternating-current power supply 32 and the heater 14, the triac including the first main electrode T1, the second main electrode T2, and the gate electrode G; the phototriac coupler PTC1 that transmits a heater trigger signal to the gate electrode G of the triac Q2; the resistors R13 and R14 as two resistors to be used for current limiting in accordance with a phase control enable signal indicative of a period of phase control; and the resistor selection circuit 36 that selects one of the two resistors (the resistors R13 and R14) to connect the selected resistor to the second main electrode T2 of the triac Q2. The resistors R13 and R14 is each connected in series to the phototriac coupler PTC1 and have different rated powers and different breakabilities.

According to this aspect, the resistor selection circuit 36 can select one of the two resistors (the resistors R13 and R14) and connect the selected resistor to the second main electrode T2 of the triac Q2.

Accordingly, the heater control device that can switch the resistor to the current limiting resistor (resistor R13) that can withstand a high-voltage pulse input during the phase control of the heater, whereas switch the resistor to the current limiting resistor (resistor R14) that is likely to be broken in an abnormal situation during full energization control of the heater can be provided.

### Second Aspect

In the heater control device D1 according to the first aspect, the two resistors are: the resistor R13 (first resistor) connected in series to the phototriac coupler PTC1; and the resistor R14 (second resistor) connected in series to the phototriac coupler PTC1 and having a rated power and a breakability different from a rated power and a breakability of the resistor R13 (first resistor). The resistor selection circuit 36 includes: the switch circuit SW1 that selects and couples one of the resistor R13 (first resistor) and the resistor R14 (second resistor).

According to this aspect, when the phase control is performed on the heater 14, the resistor selection circuit 36 selects the resistor R13 (first resistor) using the switch circuit SW1 to connect the resistor R13 (first resistor) in series to the phototriac coupler PTC1.

Accordingly, the heater control device that can switch the resistor to the current limiting resistor (resistor R13) that can withstand a high-voltage pulse input during the phase control of the heater, whereas switch the resistor to the current limiting resistor (resistor R14) that is likely to be broken in an abnormal situation during full energization control of the heater can be provided.

### Third Aspect

In the heater control device D2 according to the first aspect, the two resistors are: the resistor R13 (first resistor) connected in series to the phototriac coupler PTC1; and the resistor R14 (second resistor) connected in series to the phototriac coupler PTC1 and having a rated power and a breakability different from a rated power and a breakability of the resistor R13 (first resistor). The resistor selection circuit 36a includes: the photocoupler PC3 (first photocoupler) connected in series to the resistor R13 (first resistor); and the photocoupler PC4 (second photocoupler) connected in series to the resistor R14 (second resistor). The resistor selection circuit 36a turns on the photocoupler PC3 (first photocoupler) to connect the resistor R13 (first resistor) in series to the phototriac coupler PTC1 when the phase control is performed on the heater 14, whereas the resistor selection circuit 36a turns on the photocoupler PC4 (second photocoupler) to connect the resistor R14 (second resistor) in series to the phototriac coupler PTC 1 when full energization control is performed on the heater 14.

According to this aspect, the resistor selection circuit 36a can turn on the photocoupler PC3 to connect the resistor R13 (first resistor) in series to the phototriac coupler PTC1 when the phase control is performed on the heater 14, whereas the resistor selection circuit 36a can turn on the photocoupler PC4 to connect the resistor R14 (second resistor) in series to the phototriac coupler PTC1 when full energization control is performed on the heater 14.

Accordingly, the heater control device that can switch the resistor to the current limiting resistor (resistor R13) that can withstand a high-voltage pulse input during the phase control of the heater, whereas switch the resistor to the current limiting resistor (resistor R14) that is likely to be broken in an abnormal situation during the full energization control of the heater can be provided.

### Fourth Aspect

The heater control device according to any one of the first to third aspects includes the controller 34 that generates the phase control enable signal indicative of the period of the phase control. The resistor selection circuit 36 selects a resistor in accordance with the phase control enable signal supplied from the controller 34.

According to this aspect, the resistor selection circuit 36 can select a resistor in accordance with the phase control enable signal supplied from the controller 34.

Accordingly, the heater control device that can switch the resistor to the current limiting resistor that can withstand a high-voltage pulse input during the phase control of the heater, whereas switch the resistor to the resistor that is likely to be broken in an abnormal situation during full energization control of the heater can be provided.

### Fifth Aspect

The heater control device D3 according to this aspect includes the triac Q2 connected in series between the alternating-current power supply 32 and the heater 14, the triac Q2 including the first main electrode T1, the second main electrode T2, and the gate electrode G; the phototriac coupler PTC2 (first phototriac coupler) that transmits a heater trigger signal to the gate electrode G of the triac Q2; the resistor R21 (first resistor) to be used for a current limit, connected in series between the second main electrode T2 of the triac Q2 and the phototriac coupler PTC2 (first phototriac coupler); the phototriac coupler PCT3 (second phototriac coupler) that transmits a heater trigger signal to the gate electrode G of the triac Q2; the resistor R22 (second resistor) connected in series between the second main electrode T2 of the triac Q2 and the phototriac coupler PTC3 (second phototriac coupler), to be used for a current limit, having a rated power and a breakability different from a rated power and a breakability of the resistor R21 (first resistor); and the selection and driving circuit 38 that selects and drives one of the phototriac coupler PTC2 (first phototriac coupler) and the phototriac coupler PTC3 (second phototriac coupler).

According to this aspect, since the selection and driving circuit 38 can select and drive one of the phototriac coupler PTC2 and the phototriac coupler PTC3, one resistor of the resistor R21 (first resistor) and the resistor R22 (second resistor) can be connected in series to the phototriac coupler.

Accordingly, the heater control device that can switch the resistor to the current limiting resistor (resistor R21) that can withstand a high-voltage pulse input during the phase control of the heater, whereas switch the resistor to the current limiting resistor (resistor R22) that is likely to be broken in an abnormal situation during full energization control of the heater can be provided.

### Sixth Aspect

In the heater control device D3 according to the fifth aspect, the selection and driving circuit 38 turns on the phototriac coupler PTC2 (first phototriac coupler) to couple the resistor R21 (first resistor) in series to the phototriac coupler PTC2 when phase control is performed on the heater 14.

According to this aspect, when the phase control is performed on the heater 14, the selection and driving circuit 38 turns on the phototriac coupler PTC2 to couple the resistor R21 (first resistor) in series to the phototriac coupler PTC2.

Accordingly, the heater control device that can switch the resistor to the current limiting resistor (resistor R21) that can withstand a high-voltage pulse input during the phase control of the heater, whereas switch the resistor to the current limiting resistor (resistor R22) that is likely to be broken in an abnormal situation during full energization control of the heater can be provided.

### Seventh Aspect

The heater control device D4 according to this aspect includes: the triac Q2 connected in series between the alternating-current power supply 32 and the heater 14, the triac Q2 including the first main electrode T1, the second main electrode T2, and the gate electrode G; the phototriac coupler PTC5 that transmits a heater trigger signal to the gate electrode G of the triac Q2; the resistor R24 and the resistor R25 serving as two resistors connected in series between the second main electrode T2 of the triac Q2 and the phototriac coupler PTC5; and the voltage-peak-value suppression circuit 40 that reduces a peak of a voltage that is generated at the node 39 between the resistor R24 and the resistor R25 serving as the two resistors in accordance with a phase control enable signal indicative of a period of phase control.

According to this aspect, the voltage-peak-value suppression circuit 40 can reduce the peak of the voltage that is generated at the node 39 between the resistor R24 and the resistor R25 in accordance with the phase control enable signal indicative of the period of the phase control.

Accordingly, since the peak of the voltage that is generated at the node 39 between the resistor R24 and the second resistor R25 can be suppressed, a rapid voltage increase or a rapid current increase during the phase control can be suppressed, and even when fuse resistors that are likely to be blown in an abnormal situation are used for the resistor R24 and the resistor R25, the fuse resistors can be prevented from blowing during a normal operation.

That is, the peak of the voltage that is generated in the current limiting resistor (resistor R24 and resistor R25) including the resistor R24 and the second resistor R25 can be reduced in accordance with the phase control enable signal.

### Eighth Aspect

The voltage-peak-value suppression circuit 40 of the heater control device D4 according to the seventh aspect includes: the capacitor C2 connected to the node 39 between the resistor R24 and the resistor R25 serving as the two resistors; and the photocoupler PC5 connected to the capacitor C2. The voltage-peak-value suppression circuit 40 turns on the photocoupler PTC5 and grounds the capacitor C2 connected to the node 39 to form a low pass filter circuit when the phase control is performed on the heater 14.

According to this aspect, when the phase control is performed on the heater 14, the photocoupler PC5 is turned on and the capacitor C2 connected to the node 39 between the resistor R24 and the resistor R25 is grounded to define the low pass filter circuit.

Accordingly, when the phase control is performed on the heater 14, the low pass filter circuit can be defined, and hence a rapid voltage increase or a rapid current increase during the phase control can be prevented using a simple circuit including a resistor and a capacitor.

### Ninth Aspect

An image forming apparatus 1 according to this aspect includes: the heater control device according to any one of the first to eighth aspects; and the fixing device 9 incorporating the heater that is controlled by the heater control device.

According to this aspect, the image forming apparatus 1 including the heater control device according to any one of the first aspect to the eighth aspect; and the fixing device 9 incorporating the heater that is controlled by the heater control device can be provided.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. A heater control device comprising:
a triac connected in series between an alternating-current power supply and a heater, the triac including a first main electrode, a second main electrode, and a gate electrode;
a phototriac coupler configured to transmit a heater trigger signal to the gate electrode of the triac;
a first resistor and a second resistor each of which is connected in series to the phototriac coupler and configured to limit current in accordance with a phase control enable signal indicative of a period of phase control, the first resistor and the second resistor having different rated powers and different breakabilities from each other; and
a resistor selection circuit configured to select one of the first resistor and the second resistor and connect the selected resistor to the second main electrode of the triac.

2. The heater control device according to claim 1,
wherein the resistor selection circuit includes a switch circuit configured to select the one of the first resistor and the second resistor and connect the selected resistor to the second main electrode of the triac.

3. The heater control device according to claim 1,
wherein the resistor selection circuit includes:
a first photocoupler connected in series to the first resistor; and
a second photocoupler connected in series to the second resistor, and
wherein the resistor selection circuit turns on the first photocoupler to connect the first resistor in series to the phototriac coupler in a case where the phase control is performed on the heater, and the resistor selection circuit turns on the second photocoupler to connect the second resistor in series to the phototriac coupler in a case where full energization control is performed on the heater.

4. The heater control device according to claim 1, further comprising a control circuit configured to generate the phase control enable signal indicative of the period of the phase control,
wherein the resistor selection circuit selects a resistor in accordance with the phase control enable signal supplied from the control circuit.

5. An image forming apparatus comprising:
the heater control device according to claim 1; and
a fixing device including the heater controlled by the heater control device.

6. A heater control device comprising:
a triac connected in series between an alternating-current power supply and a heater, the triac including a first main electrode, a second main electrode, and a gate electrode;
a first phototriac coupler configured to transmit a heater trigger signal to the gate electrode of the triac;
a first resistor connected in series between the second main electrode of the triac and the first phototriac coupler and configured to limit current;
a second phototriac coupler configured to transmit a heater trigger signal to the gate electrode of the triac;
a second resistor connected in series between the second main electrode of the triac and the second phototriac coupler and configured to limit current, the second resistor having a rated power and a breakability different from a rated power and a breakability of the first resistor; and
a selection and driving circuit configured to select and drive one of the first phototriac coupler and the second phototriac coupler.

7. The heater control device according to claim 6,
wherein the selection and driving circuit turns on the first phototriac coupler to connect the first resistor in series to the first phototriac coupler in a case where phase control is performed on the heater.

8. An image forming apparatus comprising:
the heater control device according to claim 6; and
a fixing device including the heater controlled by the heater control device.

9. A heater control device comprising:
a triac connected in series between an alternating-current power supply and a heater, the triac including a first main electrode, a second main electrode, and a gate electrode;
a phototriac coupler configured to transmit a heater trigger signal to the gate electrode of the triac;
two resistors connected in series between the second main electrode of the triac and the phototriac coupler; and
a voltage-peak-value suppression circuit configured to reduce a peak of a voltage that is generated at a node between the two resistors in accordance with a phase control enable signal indicative of a period of phase control.

10. The heater control device according to claim 9,
wherein the voltage-peak-value suppression circuit includes:
a capacitor connected to the node between the two resistors; and
a photocoupler connected to the capacitor, and
wherein the voltage-peak-value suppression circuit is configured to turn on the photocoupler and ground the capacitor connected to the node to form a low pass filter circuit in a case where the phase control is performed on the heater.

11. An image forming apparatus comprising:
the heater control device according to claim 9; and
a fixing device including the heater controlled by the heater control device.
